(19) United States
(12) Patent Application Publication
(10) Pub. No.: US 2010/0084533 A1
(43) Pub. Date: Apr. 8, 2010

(54) Bracing Attachment Device for Concrete Column Forms

(75) Inventors: Daniel F. Dunmire, Stony Brook, NY (US); Pete D. Gioldasis, Florence, SC (US); Charles W. Lounsbury, JR., Florence, SC (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignees: SONOCO DEVELOPMENT, INC.; DAVIS AIRCRAFT PRODUCTS CO., INC.

(21) Appl. No.: 12/244,005

(22) Filed: Oct. 2, 2008

(51) Int. Cl. F16M 13/00; B25B 25/00

(52) U.S. Cl. 248/354.3; 254/251

(57) ABSTRACT

A toggle device for attachment to a form-engaging assembly securable about the upper end of a concrete form. The toggle device can toggle between two different configurations. One configuration is suitable for attachment directly to a brace, and the other configuration is suitable for attachment to a nail plate on a brace. In one embodiment, the toggle device comprises a base plate to which an elongate first member is rigidly affixed. An elongate second member is connected to the first member by a sliding pivot connection. The sliding pivot connection is such that the second member can be moved from one position in which it is parallel to and overlapping with the first member, to another position in which it is generally perpendicular to the first member, to yet another position in which it is oblique to the first member.

### BACKGROUND OF THE INVENTION

The present disclosure relates generally to the bracing of a concrete column form for ensuring that the form remains plumb while the concrete is poured and during curing of the concrete. The present disclosure relates more particularly to a bracing attachment device adapted to be secured about a column form, the device providing attachment sites to which braces can be attached.

Conventionally, a concrete column form is encircled at its top end by a square frame constructed from 2×4 boards or the like. The frame is affixed to the form in suitable fashion, and a pair of long braces (typically also made from 2×4s) are nailed to the frame and extend down to engage the ground. The process for bracing a column form in this manner is relatively cumbersome.

### BRIEF SUMMARY OF THE DISCLOSURE

In Europe, a flexible strap with an attachment fitting has been used for encircling the upper end of a concrete form. The fitting has a threaded bolt and nut. In one technique, a hole is drilled through the end of a 2×4 brace and the threaded bolt is inserted through the hole and the nut is engaged with the bolt to secure the brace to the fitting. In another technique, a nail plate is nailed to the end of the brace and defines a hole for receiving the bolt of the attachment fitting, the nut then securing the nail plate to the fitting.

It is not uncommon for a worker perched on a ladder at the top end of the concrete form to drop the nut while trying to thread it onto the bolt. Not only is this a potential hazard for people below, but it is also an annoyance for the worker, who must then descend the ladder to retrieve the nut, thus wasting time.

In accordance with embodiments disclosed herein, a toggle device is provided for attachment to a form-engaging assembly securable about the upper end of a concrete form. The toggle device is configured to attach to a brace either directly or via a nail plate attached to the end of the brace. The toggle device does not have any nut or other part that must be removed and then replaced in order to secure the brace to the fitting. Instead, the toggle device can toggle between two different configurations. One configuration is suitable for attachment directly to a brace, and the other configuration is suitable for attachment to a nail plate on a brace.

In one embodiment, the toggle device comprises a base plate to which an elongate first member is rigidly affixed so that it projects from the base plate. An elongate second member is connected to the first member by a sliding pivot connection. The sliding pivot connection is such that the second member can be moved from one position in which it is parallel to and overlapping with the first member, to another position in which it is generally perpendicular to the first member, to yet another position in which it is oblique to the first member. In one embodiment, the second member can rotate a full 360 degrees about the pivot connection.

To connect the toggle device to a 2×4 brace, the second member is placed in the parallel overlapping position and the first and second members are inserted through a hole in the brace. The second member is extended via the sliding connection until it fully emerges from the hole on the opposite side of the brace from the base plate, and then the second member is pivoted into a position preventing the toggle device from being withdrawn through the hole, thus capturing the brace. In one embodiment the second member is positioned substantially perpendicular to the first member to capture the brace.

To connect the toggle device to a nail plate on a brace, the second member is placed in the parallel overlapping position and the members are inserted through a hole in the nail plate. The second member is then pivoted into a position preventing the toggle device from being withdrawn through the hole in the nail plate, thus capturing the nail plate. In one embodiment the second member is positioned obliquely to the first member to capture the nail plate.

In one embodiment, the form-engaging assembly comprises a flexible strap. The base plate of the first toggle device can include a pair of slots spaced apart along a length of the base plate, the strap being passed through the slots to secure the first toggle device to the strap.

In order to secure two braces to the column form, a second toggle device substantially identical to the first toggle device can be secured to the strap, the first and second toggle devices being spaced apart along a length of the strap. In one embodiment, the toggle devices can be slid to various positions along the strap for adjusting the toggle devices to accommodate column forms of different circumferences.

The strap can include a pair of cooperative connecting devices affixed to the strap, the connecting devices being configured to connect to each other to form the strap into a loop about the column form. The strap can also include a tensioning device operable to constrict the loop about the column form.

In one embodiment, one of the first and second members of the first toggle device has a slot that is elongated along the longitudinal axis of the member, and the other of the first and second members supports a pivot pin engaged in the slot such that the pivot pin can slide along the slot. In a particular embodiment, the slot is defined in the second member and the pivot pin is affixed to the first member. The first member can be generally U-shaped having a pair of spaced legs, and the pivot pin can be connected between the legs. In this embodiment, the second member is received between the legs.

In one embodiment, the first toggle device is configured such that when the second member is in the perpendicular position a minimum distance between opposing surfaces of the base plate and second member is adequate for accommodating a thickness of a 2×4 or 4×4 board therebetween. A 2×4 board typically has a thickness of about 1.5 inches, while a 4×4 board is about 3.5 inches thick, and hence the minimum distance is about 1.5 inches to about 3.5 inches. When the second member is in the oblique position a minimum distance between opposing surfaces of the base plate and second member is adequate for accommodating a thickness of a 1/16-inch thick plate therebetween. In all embodiments, the minimum distance in the oblique position is substantially smaller than the minimum distance in the perpendicular position.

The sliding pivot connection is structured and arranged such that when the second member is in either the perpendicular position or the oblique position, the second member is substantially prevented from moving away from the base plate to increase the minimum distances.

### BRIEF DESCRIPTION OF THE SEVERAL VIEWS OF THE DRAWING(S)

Having thus described the disclosure in general terms, reference will now be made to the accompanying drawings, which are not necessarily drawn to scale, and wherein:

FIG. 1 is a perspective view showing a bracing attachment device in accordance with one embodiment of the invention secured about a column form;

FIG. 2 is a perspective view of a toggle fitting used on the bracing attachment device in accordance with one embodiment of the invention;

FIG. 3 is a side elevation of a bracing attachment device in accordance with one embodiment of the invention, in an unwrapped configuration;

FIG. 4 is a top elevation of the bracing attachment device of FIG. 2;

FIG. 5 is a perspective view of a portion of the toggle fitting of FIG. 2;

FIG. 6 is an end elevation of the toggle fitting of FIG. 2;

FIG. 7 is a side elevation of the toggle fitting of FIG. 2;

FIG. 8 is a perspective view showing the bracing attachment device in accordance with one embodiment of invention secured to a nail plate on a brace;

FIG. 9 is a side view showing the toggle fitting after insertion through a hole in the nail plate;

FIG. 10 is a view similar to FIG. 9, after pivoting of the movable member of the toggle fitting into the oblique position;

FIG. 11 is a perspective view showing the bracing attachment device in accordance with one embodiment of the invention secured directly to a brace; and

FIG. 12 is a side view showing the toggle fitting after insertion through a hole in the brace and pivoting of the movable member into the perpendicular position.

### DETAILED DESCRIPTION OF THE DRAWINGS

The present invention now will be described more fully hereinafter with reference to the accompanying drawings in which some but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

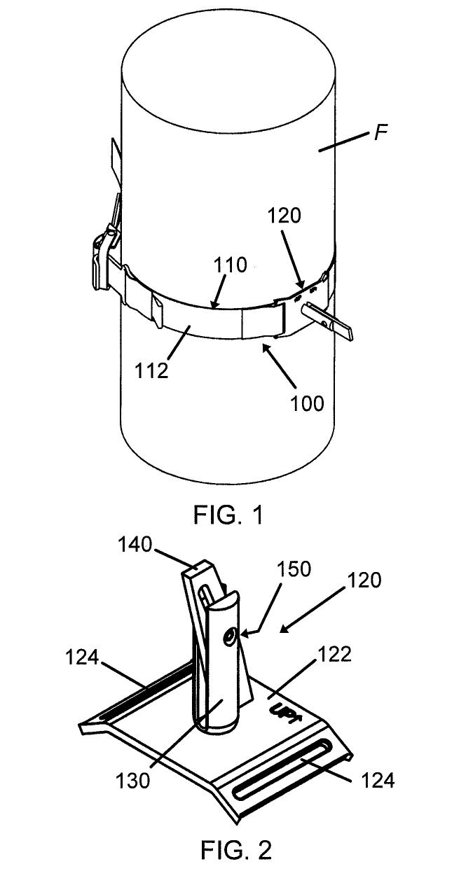

FIG. 1 depicts a concrete column form F having a bracing attachment device 100 in accordance with one embodiment of the invention wrapped about the form. It will be understood that in general a column form is substantially longer than its diameter, and that FIG. 1 shows only the upper portion of the form near the top end of the form. The form F is illustrated as circular in cross-section, but alternatively the form can have other cross-sectional shapes such as square, rectangular, oblong, oval, etc. In the case of circular forms, the form can be a wound paperboard tube, for example. However, the invention is not limited in any way by the particular construction or configuration of the form.

The bracing attachment device 100 is used for attaching one or more elongate braces to the form in order to brace the form in a plumb orientation while the wet concrete is being poured into the form and while the concrete is curing. Typically, two such braces are attached to the form and each extends obliquely down to engage the ground or other stable support surface. The two braces typically are orientated at 90 degrees to each other, i.e., one brace attaches to the form at a first circumferential location about the form's circumference and lies generally in a vertical plane that contains the central longitudinal axis of the form as well as the point of attachment of the brace to the form, and the other brace attaches to the form at a second circumferential location spaced 90 degrees from the attachment location of the first brace and lies generally in a vertical plane that contains the longitudinal axis of the form and the second attachment point and that is orthogonal to the plane of the first brace. However, the particular orientation and number of braces are not limitations in the present invention.

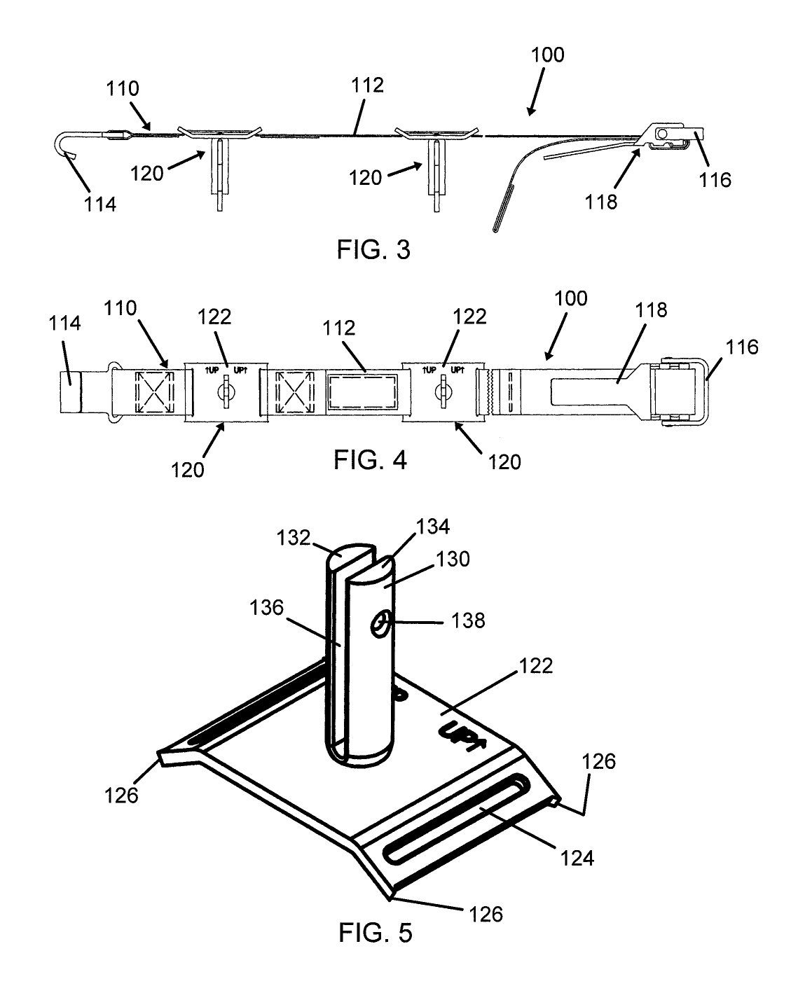

In accordance with one embodiment of the invention, the bracing attachment device 100 includes a form-engaging assembly 110 structured and arranged to be secured about the upper end portion of the column form F. Secured to the form-engaging assembly 110 is at least one toggle device 120 serving as the device that attaches a brace to the form. In the illustrated embodiment (as particularly evident from FIGS. 3 and 4), the bracing attachment device 100 includes two toggle devices 120 spaced apart from each other. However, the invention is not limited to any particular number of toggle devices.

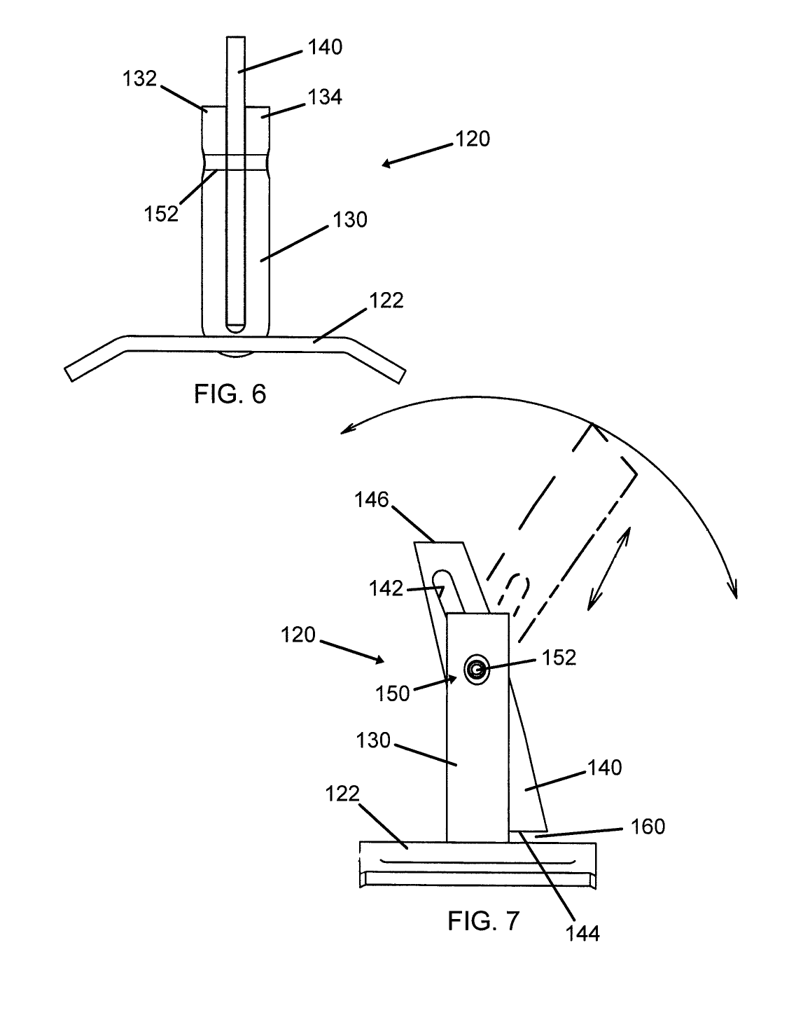

With particular reference to FIGS. 2, 5, 6, and 7, the or each toggle device 120 includes a base plate 122 configured to be affixed to the form-engaging assembly 110. In the illustrated embodiment, the form-engaging assembly 110 comprises a flexible strap 112 of a suitable length to wrap about the circumference of the form F with enough excess length to allow the ends of the strap 112 to be secured to each other and to tighten the strap 112 about the form. Accordingly, the base plate 122 includes a pair of slots 124 spaced apart along a length direction of the base plate 122 and oriented parallel to each other and to a width direction of the base plate, for receiving the strap 112 therethrough, thereby securing the base plate to the strap. As shown, if desired the opposite end portions of the base plate having the slots 124 can be orientated at oblique angles to the plane of the medial portion of the base plate to aid in threading the strap through the slots; however, this is strictly optional and not essential. The base plate 122 includes a sharp or pointed projection 126 at each of its four corners. The projections 126 dig into the softer material of the concrete form when the strap 112 is tightened about the form, and thereby help prevent the toggle device from shifting position when loads are applied by the brace attached to the toggle device.

The toggle device 120 further includes an elongate first member 130 affixed to the base plate 122 and projecting from one side of the base plate in a direction generally orthogonal to a main plane in which a majority of the base plate lies. In the illustrated embodiment, the medial portion of the base plate is substantially planar, and the first member 130 is substantially orthogonal to the plane of the medial portion. However, precise perpendicularity of the first member is not essential to the functioning of the toggle device. The toggle device also includes an elongate second member 140 connected to the first member 130 by a sliding pivot connection 150 enabling the second member to slide and pivot relative to the first member. Accordingly, the second member is movable between a plurality of different positions in which the first and second members at least partially overlap, such positions including a parallel position in which longitudinal axes of the first and second members are substantially parallel to each other, a perpendicular position in which the longitudinal axes are substantially perpendicular to each other, and an oblique position in which the longitudinal axes form an oblique angle therebetween. This is further explained below.

In the illustrated embodiment, the first member 130 is a U-shaped structure such that the first member has a pair of spaced parallel legs 132, 134 with a space or slot 136 therebetween. The closed end of the U-shaped first member 130 is affixed to the base plate 122 and the open end is the opposite end remote from the base plate. At a location spaced from the base plate 122 in a direction toward the distal end of the first member 130, each leg 132, 134 has an aperture 138 formed through it, the two apertures being aligned along a pivot axis that is substantially perpendicular to the length of the first member 130 and substantially parallel to the plane of the base plate 122.

The second member 140 comprises a generally flat elongate bar having a thickness slightly less than a width of the space 136 between the legs 132, 134 of the first member 130. An elongate slot 142 is defined in the second member, a length direction of the slot extending longitudinally along the length of the second member. The second member 140 is received in the space 136 between the legs of the first member 130. A pivot pin 152 extends through the apertures 138 in the legs and through the slot 142 in the second member, thereby capturing the second member and forming the sliding pivot connection 150. The sliding pivot connection allows the second member 140 to slide in the direction defined by the slot 142 and to pivot about an axis defined by the pivot pin 152.

The spacing of the pivot pin 152 from the base plate, the length of the second member, and the length and location of the slot 142 in the second member 140 are selected so that the second member can be positioned with the pivot pin 152 all the way toward the inner end of the slot 142 (i.e., the end closer to the base plate 122) with the second member 140 oriented obliquely relative to the first member 130, such that there is a relatively small gap 160 of predetermined thickness between one end 144 of the second member 140 and the opposing surface of the base plate 122 as shown in FIG. 7. The engagement of the pivot pin 152 in the end of the slot 142 prevents the second member 140 from being able to slide outwardly and thus the gap's maximum width is limited in this manner. The gap 160 represents the minimum distance between the opposing surfaces of the base plate and second member, and is sized to accommodate a thickness of a nail plate affixed to one end of a brace for a column form. Typically, the nail plates in common use have a thickness of 1/16-inch. However, the gap 160 can be sized to accommodate any desired plate thickness.

As will be appreciated, the pivot pin 152 also enables the second member 140 to pivot into various other positions relative to the first member 130, including a position in which the second member's longitudinal axis is substantially perpendicular to the longitudinal axis of the first member, as shown in FIG. 12. In this perpendicular position, a gap between opposing surfaces of the second member and base plate is substantially larger than the gap 160 defined in the oblique position. Since the braces used for bracing column forms typically are 2×4 boards having a thickness of about 1.5 inches, the gap in the perpendicular position desirably is able to accommodate the thickness of about 1.5 inches. However, in some cases 4×4 boards are used as braces, and these typically have a thickness of about 3.5 inches. Thus, the gap in the perpendicular position can be sized to accommodate either 1.5 inch thick braces, or 3.5 inch thick braces (but not both sizes), or any other desired thickness. It will also be noted that the slot 142 in the second member 140 is not perfectly parallel to the longitudinal axis of the second member, but rather is at a small angle relative the longitudinal axis. As a result, when the second member is in the perpendicular position (FIG. 12) and slides on the pivot pin, the distance between the second member and the base plate changes, becoming slightly larger when the second member is slid in one direction and slightly smaller when the second member is slid in the opposite direction. This allows the second member to tightly grip the brace even if the brace varies slightly in thickness relative to the “nominal” thickness.

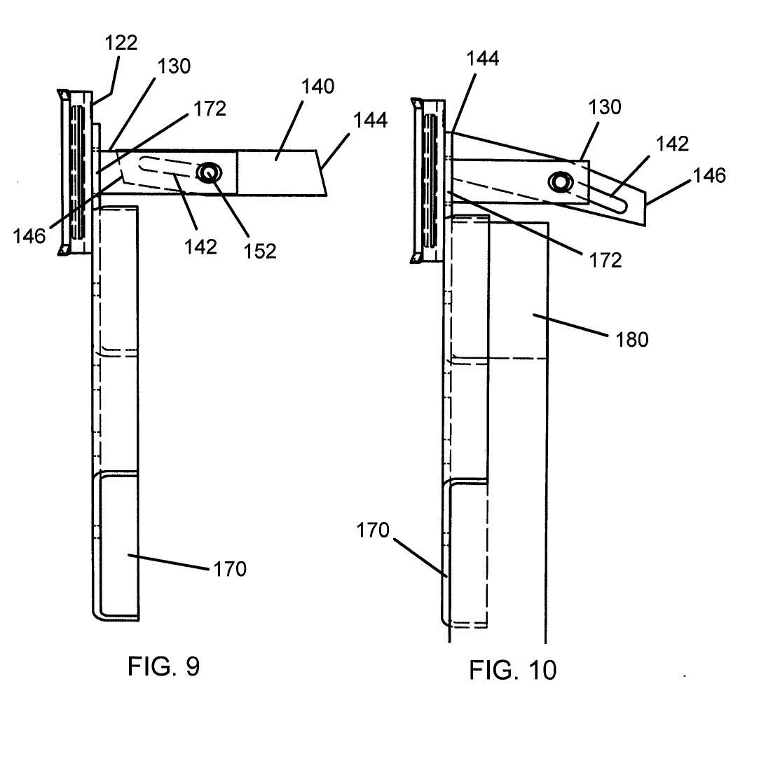

The second member 140 can also be pivoted into a position in which it is parallel to the first member 130, with the opposite end 146 of the second member adjacent the base plate 122 as shown in FIG. 9. The members 130, 140 in this overlapping parallel position present a combined maximum width (measured in the direction parallel to the base plate, i.e., left-to-right in FIG. 7) defined by the wider of the members. This maximum width is selected in relation to the diameter of the hole in the brace or nail plate so that the members can be inserted through the hole. The hole typically is about ¾-inch in diameter. Thus, the maximum width of the overlapping parallel members can be slightly less than this, such as about 0.7 inch or less.

With reference again to FIGS. 3 and 4, further details of one embodiment of the bracing attachment device 100 are explained. In the illustrated embodiment, the form-engaging assembly 110 is constructed from a flexible strap 112. The strap can be a nylon fabric of the type commonly used for vehicle seat belts and for tie-down straps. Such fabric is essential inextensible under tension in the length direction. The strap can have any suitable width; conveniently, the width can be about 2 inches, but the invention is not in any way limited to a particular width. A flat hook 114 is attached to one end of the strap 112. The other end of the strap 112 is threaded through a tensioning device 118 that includes a catch or latch 116 that can receive the hook 114. Accordingly, the strap can be wrapped about a column form and the hook 114 can be engaged with the latch 116, and then the tensioning device 118 can be operated to cinch up the strap until it is as tight as desired. Any suitable tensioning device can be used. The length of the strap preferably is sufficient to encircle the largest-circumference column form with which the device 100 is expected to be used, plus an extra amount to allow the strap to be threaded through the tensioning device. For example, if the largest form has a diameter of 36 inches, and thus a circumference of about 113 inches, then the strap can be about 130 inches long.

As shown, the bracing attachment device 100 has two toggle devices 120 spaced apart along the strap 112. One length of the strap is affixed to the flat hook 114 at one end, and the opposite end is threaded through one of the slots 124 in the base plate 120 of one of the toggle devices, through the slot at the other end of the first toggle device, then through the slot at one end of the second toggle device, then through the slot at the other end of the second toggle device, and finally the opposite end of the strap is threaded through the tensioning device. This construction allows the toggle devices 120 to be slid along the strap to vary their spacing so as to accommodate column forms of various diameters.

Alternatively, the toggle devices could be immovably affixed to the strap at a fixed spacing distance. It is also possible to attach the toggle device(s) to a different kind of form-engaging assembly. For instance, the toggle device(s) could be nailed or otherwise affixed to a conventional wooden frame that is typically used to surround the upper end of a column form. Preferably, however, the form-engaging assembly 110 is made from a flexible, adjustable-length strap 112 as described herein, for reasons of speed and convenience in securing the device about the column form.

It is further possible that the toggle device 120 could be directly secured to, or integrated into, a column form or any other type of concrete form requiring bracing.

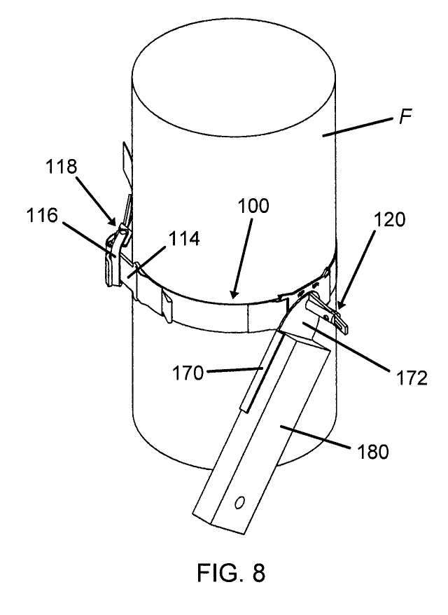

The use of the bracing attachment device 100 is now explained with reference to FIGS. 8-12. As previously noted, it is common to brace column forms using 2×4 boards as braces. There are two common ways of attaching a 2×4 brace to a form. In one approach illustrated in FIGS. 8-10, a nail plate 170 is first affixed to the end of the brace 180. The nail plate is typically made of 1/16-inch thick sheet metal. A portion 172 of the nail plate projects beyond the end of the 2×4 brace 180, and a hole is provided in this portion of the nail plate for receiving a fitting secured to the column form. As already noted, prior to the present invention this was sometimes accomplished using a threaded bolt and nut. The other common approach has been to omit the nail plate and directly attach the 2×4 brace to the fitting by providing a hole through the brace.

The use of the bracing attachment device 100 according to the first approach is now explained with reference to FIGS. 8-10. The first step is to secure the device 100 about the upper end of the column form F. This is accomplished by wrapping the device about the form and engaging the flat hook 114 with the catch 116, and then cinching the strap using the tensioning device 118. Before the strap is fully tightened, the toggle devices 120 are slid (if necessary) along the strap to position them in the desired locations. Typically it is desired to have the toggle devices spaced 90 degrees apart about the circumference of the form, as previously described.

Next, the first toggle device 120 is put into the parallel position in which the first member 130 and second member 140 are parallel and overlapping, with the end 146 of the second member proximate to the base plate 122. The members 130, 140 are inserted through the hole in the nail plate portion 172 until the nail plate portion is abutting the base plate 122 as shown in FIG. 9. The second member 140 is then rotated through an angle substantially greater than 90 degrees but less than 180 degrees until the opposite end 144 of the second member abuts the nail plate portion 172 as shown in FIG. 10. In the illustrate embodiment, the end 144 of the second member is a surface oriented at a non-perpendicular angle to the longitudinal axis of the second member such that the end 144 lies substantially flush against the nail plate portion 172 when the second member 140 is rotated sufficiently to produce an interference fit or clamping force against the nail plate portion. The clamping action is provided by virtue of the pivot pin 152 being up against the end of the slot 142 in the second member, which prevents the second member from being able to move away from the nail plate portion. This position of the second member 140 is referred to herein as the oblique position, since the longitudinal axis of the second member forms an oblique angle (i.e., neither perpendicular nor parallel) with the longitudinal axis of the first member 130. The brace is thus secured to the toggle device 120.

If there is a second toggle device 120 on the device 100, a second brace is attached to it in the same way described above.

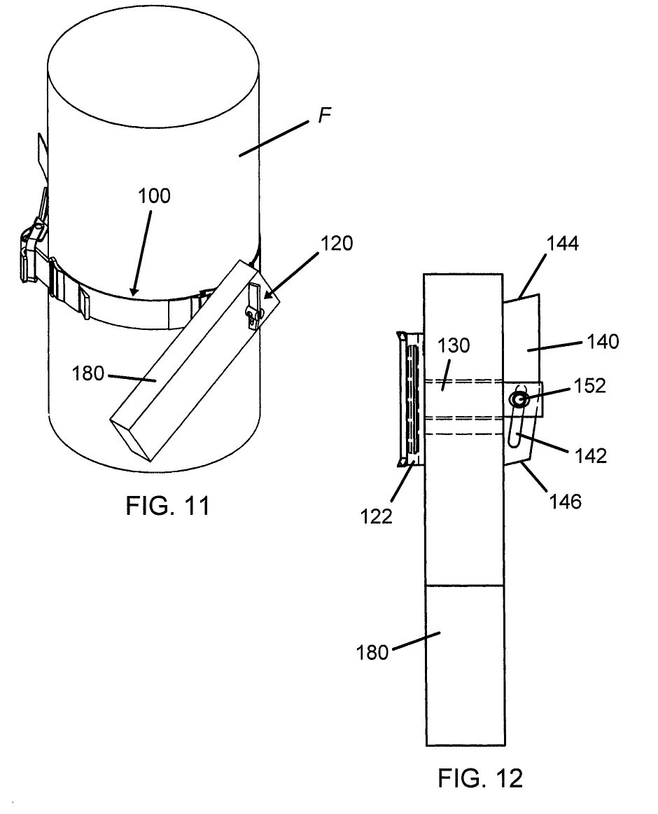

FIGS. 11 and 12 illustrate the use of the device 100 to attach directly to a brace 180 not having a nail plate. After securing the device 100 about the form in the manner described above, the first toggle device 120 is placed into the parallel position and inserted through a hole in the end of the brace 180. The second member 140 is then slid outwardly away from the base plate 122 as far as it will go (see the phantom line position in FIG. 7) so that both ends 144, 146 of the second member are free of the hole in the brace. The second member is then rotated to the perpendicular position as shown in FIG. 12. In this perpendicular position, one longitudinal edge of the second member abuts or is closely adjacent to the opposing surface of the brace. The brace is thus secured to the toggle device 120. If there is a second toggle device 120 on the device 100, a second brace is attached to it in the same way.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A bracing system for bracing a vertical concrete column form, comprising:
a form-engaging assembly structured and arranged to be secured about an upper end portion of the column form;
an elongate first brace having a lower end for engagement with the ground and an upper end for engagement with the form-engaging assembly; and
a first toggle device secured to the form-engaging assembly, the first toggle device comprising a base plate affixed to the form-engaging assembly, an elongate first member affixed to the base plate and projecting generally outwardly from the form-engaging assembly, and an elongate second member connected to the first member by a sliding pivot connection enabling the second member to slide and pivot relative to the first member, the second member being movable between a plurality of different positions including a parallel position in which longitudinal axes of the first and second members are substantially parallel to each other, a perpendicular position in which the longitudinal axes are substantially perpendicular to each other, and an oblique position in which the longitudinal axes form an oblique angle therebetween;
the first toggle device being releasably engageable with the first brace by capturing a portion of the first brace between the base plate and the second member.

2. The bracing system of claim 1, wherein the form-engaging assembly comprises a flexible strap.

3. The bracing system of claim 2, wherein the base plate includes a pair of slots spaced apart along a length of the base plate, and the strap passes through the slots to secure the first toggle device to the strap.

4. The bracing system of claim 3, further comprising a second toggle device substantially identical to the first toggle device, the first and second toggle devices being secured to the strap and spaced apart along a length of the strap, and an elongate second brace with which the second toggle device is releasably engageable.

5. The bracing system of claim 2, further comprising a pair of cooperative connecting devices affixed to the strap, the connecting devices being configured to connect to each other to form the strap into a loop about the column form, and further comprising a tensioning device arranged to constrict the loop about the column form.

6. The bracing system of claim 1, wherein one of the first and second members of the first toggle device has a slot that is elongated generally along the longitudinal axis of said member, and the other of the first and second members supports a pivot pin engaged in the slot such that the pivot pin can slide along the slot.

7. The bracing system of claim 6, wherein the slot is defined in the second member and the pivot pin is affixed to the first member.

8. The bracing system of claim 7, wherein the first member is generally U-shaped having a pair of spaced legs, the pivot pin is connected between the legs, and the second member is received between the legs.

9. A bracing attachment device for securing about a concrete column form, comprising:
a flexible strap having a pair of cooperative connecting devices affixed to the strap, the connecting devices being configured to connect to each other to form the strap into a loop about the column form, and further comprising a tensioning device arranged to constrict the loop about the column form; and
a first toggle device secured to the strap, the first toggle device comprising a base plate affixed to the strap, an elongate first member affixed to the base plate and projecting generally outwardly therefrom, and an elongate second member connected to the first member by a sliding pivot connection enabling the second member to slide and pivot relative to the first member, the second member being movable between a plurality of different positions including a parallel position in which longitudinal axes of the first and second members are substantially parallel to each other, a perpendicular position in which the longitudinal axes are substantially perpendicular to each other, and an oblique position in which the longitudinal axes form an oblique angle therebetween.

10. The bracing attachment device of claim 9, wherein the base plate includes a pair of slots spaced apart along a length of the base plate, and the strap passes through the slots to secure the first toggle device to the strap.

11. The bracing attachment device of claim 10, further comprising a second toggle device substantially identical to the first toggle device, the first and second toggle devices being secured to the strap and spaced apart along a length of the strap.

12. The bracing attachment device of claim 9, wherein one of the first and second members of the first toggle device has a slot that is elongated generally along the longitudinal axis of said member, and the other of the first and second members supports a pivot pin engaged in the slot such that the pivot pin can slide along the slot.

13. The bracing attachment device of claim 12, wherein the slot is defined in the second member and the pivot pin is affixed to the first member.

14. The bracing attachment device of claim 13, wherein the first member is generally U-shaped having a pair of spaced legs, the pivot pin is connected between the legs, and the second member is received between the legs.

15. The bracing attachment device of claim 13, wherein the first toggle device is configured such that when the second member is in the perpendicular position a minimum distance between opposing surfaces of the base plate and second member is adequate for accommodating a thickness of a bracing board therebetween.

16. The bracing attachment device of claim 15, wherein the slot in the second member extends along a direction that is oriented at a small acute angle relative to the surface of the second member that opposes the base plate, such that in the perpendicular position of the second member sliding of the pivot pin in the slot of the second member changes said minimum distance between said opposing surfaces of the base plate and second member.

17. The bracing attachment device of claim 15, wherein the first toggle device is configured such that when the second member is in the oblique position a minimum distance between opposing surfaces of the base plate and second member is adequate for accommodating a thickness of a nail plate therebetween.

18. The bracing attachment device of claim 17, wherein said minimum distance in the oblique position is substantially smaller than said minimum distance in the perpendicular position.

19. The bracing attachment device of claim 17, wherein the sliding pivot connection is structured and arranged to substantially prevent the second member from moving away from the base plate when the second member is in either the perpendicular position or the oblique position.

20. A toggle device comprising:
a base plate, an elongate first member affixed to the base plate and projecting generally outwardly therefrom, and an elongate second member connected to the first member by a sliding pivot connection enabling the second member to both slide and pivot relative to the first member, the second member being movable between a plurality of different positions including a parallel position in which longitudinal axes of the first and second members are substantially parallel to each other, a perpendicular position in which the longitudinal axes are substantially perpendicular to each other, and an oblique position in which the longitudinal axes form an oblique angle therebetween.

21. The toggle device of claim 20, wherein one of the first and second members has a slot that is elongated generally along the longitudinal axis of said member, and the other of the first and second members supports a pivot pin engaged in the slot such that the pivot pin can slide along the slot.

22. The toggle device of claim 21, wherein the slot is defined in the second member and the pivot pin is affixed to the first member.

23. The toggle device of claim 22, wherein the first member is generally U-shaped having a pair of spaced legs, the pivot pin is connected between the legs, and the second member is received between the legs.

24. The toggle device of claim 22, wherein the toggle device is configured such that when the second member is in the perpendicular position a minimum distance between opposing surfaces of the base plate and second member is adequate for accommodating a thickness of a bracing board therebetween.

25. The toggle device of claim 24, wherein the first toggle device is configured such that when the second member is in the oblique position a minimum distance between opposing surfaces of the base plate and second member is adequate for accommodating a thickness of a nail plate therebetween.

26. The toggle device of claim 25, wherein said minimum distance in the oblique position is substantially smaller than said minimum distance in the perpendicular position.

27. The toggle device of claim 25, wherein the sliding pivot connection is structured and arranged to substantially prevent the second member from moving away from the base plate when the second member is in either the perpendicular position or the oblique position.
